(19) United States
(12) Patent Application Publication
(10) Pub. No.: US 2026/0021563 A1
(43) Pub. Date: Jan. 22, 2026

(54) TORQUE DETERMINATION AND CONTROL USING MACHINE LEARNING

(71) Applicant: MILWAUKEE ELECTRIC TOOL CORPORATION, Brookfield, WI (US)

(72) Inventors: Dhananjai Bajpai, Evanston, IL (US); Dapeng Zhao, Franksville, WI (US); Daniel S. Olson, Brookfield, WI (US)

(21) Appl. No.: 18/778,559

(22) Filed: Jul. 19, 2024

(51) Int. Cl. B25B 23/147; B25B 21/02; G01D 5/20

(52) U.S. Cl. CPC B25B 23/1475; B25B 21/02; G01D 5/20

(57) ABSTRACT

Systems and methods for determining output torque of a power tool. One example power tool includes a motor, an output drive device, an anvil couple to the output drive device, a hammer connected to the motor and configured to engage the anvil when driven by the motor, and a controller. The controller is configured to receive a target torque value, drive the motor based on an internal torque prediction value, and determine a difference between the target torque value and an actual torque value provided by the motor. The controller is configured to determine whether the difference between the target torque value and the actual torque value is within an acceptable range, and store, in response to the difference being within the acceptable range, the internal torque prediction value in the memory. The internal torque prediction value is associated with the target torque value in the memory.

### FIELD

Embodiments described herein relate to power tools with impact mechanisms.

### SUMMARY

Power tools described herein include a motor, an output drive device, an anvil couple to the output drive device, a hammer connected to the motor and configured to engage the anvil when driven by the motor, and a controller including an electronic processor and a memory. The controller is configured to receive a target torque value, drive the motor based on an internal torque prediction value, and determine a difference between the target torque value and an actual torque value provided by the motor. The controller is configured to determine whether the difference between the target torque value and the actual torque value is within an acceptable range, and store, in response to the difference between the target torque value and the actual torque value being within the acceptable range, the internal torque prediction value in the memory. The internal torque prediction value is associated with the target torque value in the memory.

Methods described herein include methods for calibrating an impact driver, the impact driver including a motor, an output drive device, an anvil coupled to the output drive device, and a hammer connected to the motor and configured to engage the anvil when driven by the motor. A methods include receiving a target torque value, driving the motor based on an internal torque prediction value, and determining a difference between the target torque value and an actual torque value provided by the motor. The method includes determining whether the difference between the target torque value and the actual torque value is within an acceptable range, and storing, in response to the difference between the target torque value and the actual torque value being within the acceptable range, the internal torque prediction value in a memory. The internal torque prediction value is associated with the target torque value in the memory.

Power tools described herein include a motor, an output drive device, an anvil couple to the output drive device, a hammer connected to the motor and configured to engage the anvil when driven by the motor, a hammer translation sensor configured to generate a hammer translation signal indicative of a position of the hammer, an anvil rotation sensor configured to generate an anvil rotation signal indicative of a position of the anvil, and a controller including an electronic processor and a memory. The memory stores a machine learning model and a physics model. The controller is configured to receive the hammer translation signal, receive the anvil rotation signal, provide the hammer translation signal and the anvil rotation signal to a signal processing model, the signal processing model including the physics model and the machine learning model, and determine, based on an output from the signal processing model, an estimated output torque of the power tool.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of various embodiments will become apparent by consideration of the detailed description and accompanying drawings.

### BRIEF DESCRIPTION OF THE DRAWINGS

FIG. 1 illustrates a communication system according to embodiments described herein.

FIG. 2 illustrates a power tool of the communication system of FIG. 1.

FIGS. 3A and 3B illustrate schematic diagrams of the power tool of FIG. 2.

FIGS. 4A and 4B illustrate an impact mechanism of an impact driver according to embodiments described herein.

FIGS. 5A, 5B, 6A, 6B, 7A, 7B, 8A, and 8B illustrate an exemplary operation of a hammer and an anvil of the power tool according to embodiments described herein.

FIGS. 9A and 9B illustrate an anvil position sensor of the power tool of FIG. 2 according to embodiments described herein.

FIG. 10 illustrates the output of the anvil position sensor of FIG. 9A as a function of anvil position.

FIGS. 11A, 11B, and 11C illustrate a body portion of a power tool for supporting the anvil position sensor of FIG. 9A or FIG. 9B.

FIGS. 12A and 12B illustrate an embodiment of an anvil assembly including a target positioned on the anvil shaft and a magnetic shield positioned between the target and the anvil lugs.

FIG. 13 illustrates a perspective view of an upper housing portion of the power tool of FIG. 2.

FIG. 14 illustrates an example workflow of the controller of FIG. 3A.

FIG. 15 illustrates another example workflow of the controller of FIG. 3A.

FIG. 16 illustrates another graph providing example torque values over a number of impacts.

FIGS. 17-22 illustrate example characteristic graphs for various fasteners.

FIG. 23 illustrates a graph providing example expected model torque outputs over a number of impacts.

FIG. 24 illustrates a block diagram of a method performed by the controller of FIG. 3A.

FIG. 25 illustrates a graph providing example torque values during calibration of the power tool of FIG. 2.

FIG. 26A illustrates a graph comparing commanded torque values to expected torque values.

FIG. 26B illustrates a table comparing commanded torque values to measured torque values.

FIG. 27 illustrates a block diagram of another method performed by the controller of FIG. 3A.

### DETAILED DESCRIPTION

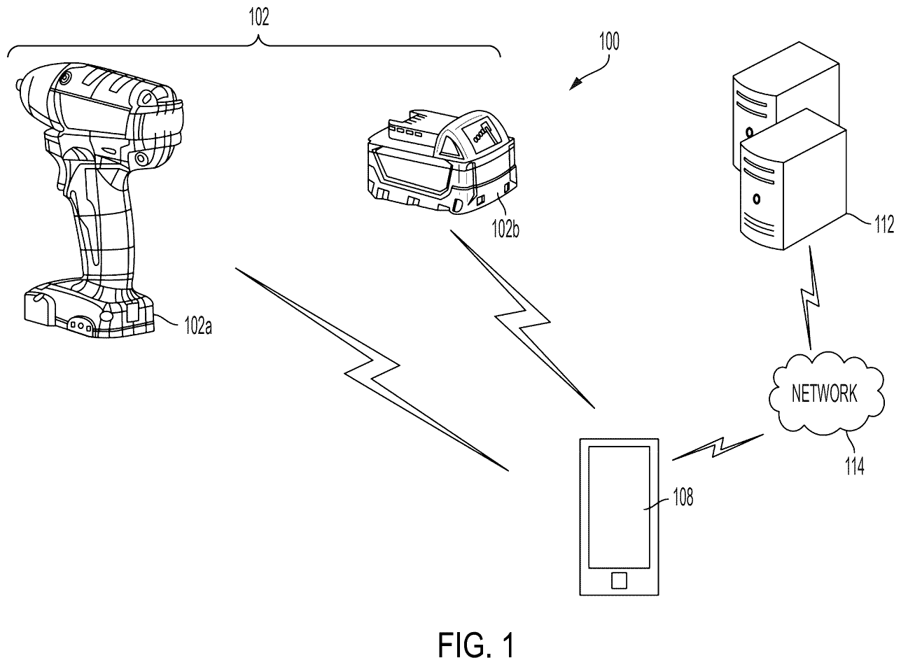

FIG. 1 illustrates a communication system 100. The communication system 100 includes power tool devices 102 and an external device 108. Each power tool device 102 (e.g., power tool 102a and power tool battery pack 102b) and the external device 108 can communicate wirelessly while they are within a communication range of each other. Each power tool device 102 may communicate power tool status, power tool operation statistics, power tool identification, stored power tool usage information, power tool maintenance data, and the like. Therefore, using the external device 108, a user can access stored power tool usage or power tool maintenance data. With this tool data, a user can determine how the power tool device 102 has been used, whether maintenance is recommended or has been performed in the past, and identify malfunctioning components or other reasons for certain performance issues. The external device 108 can also transmit data to the power tool device 102 for power tool configuration, firmware updates, or to send commands (e.g., turn on a work light). The external device 108 also allows a user to set operational parameters, safety parameters, select tool modes, and the like for the power tool device 102.

The external device 108 may be, for example, a smart phone (as illustrated), a laptop computer, a tablet computer, a personal digital assistant (PDA), or another electronic device capable of communicating wirelessly with the power tool device 102 and providing a user interface. The external device 108 provides the user interface and allows a user to access and interact with tool information. The external device 108 can receive user inputs to determine operational parameters, enable or disable features, and the like. The user interface of the external device 108 provides an easy-to-use interface for the user to control and customize operation of the power tool.

The external device 108 includes a communication interface that is compatible with a wireless communication interface or module of the power tool device 102. The communication interface of the external device 108 may include a wireless communication controller (e.g., a Bluetooth® module), or a similar component. The external device 108, therefore, grants the user access to data related to the power tool device 102, and provides a user interface such that the user can interact with the controller of the power tool device 102.

In addition, as shown in FIG. 1, the external device 108 can also share the information obtained from the power tool device 102 with a remote server 112 connected by a network 114. The remote server 112 may be used to store the data obtained from the external device 108, provide additional functionality and services to the user, or a combination thereof. In one embodiment, storing the information on the remote server 112 allows a user to access the information from a plurality of different locations. In another embodiment, the remote server 112 may collect information from various users regarding their power tool devices and provide statistics or statistical measures to the user based on information obtained from the different power tools. For example, the remote server 112 may provide statistics regarding the experienced efficiency of the power tool device 102, typical usage of the power tool device 102, and other relevant characteristics and/or measures of the power tool device 102. The network 114 may include various networking elements (routers, hubs, switches, cellular towers, wired connections, wireless connections, etc.) for connecting to, for example, the Internet, a cellular data network, a local area network (LAN), a wide area network (WAN) or a combination thereof. In some embodiments, the power tool device 102 may be configured to communicate directly with the server 112 through an additional wireless communication interface or with the same wireless communication interface that the power tool device 102 uses to communicate with the external device 108.

The power tool device 102 is configured to perform one or more specific tasks (e.g., drilling, cutting, fastening, pressing, lubricant application, sanding, heating, grinding, bending, forming, impacting, polishing, lighting, etc.). For example, an impact wrench is associated with the task of generating a rotational output (e.g., to drive a bit).

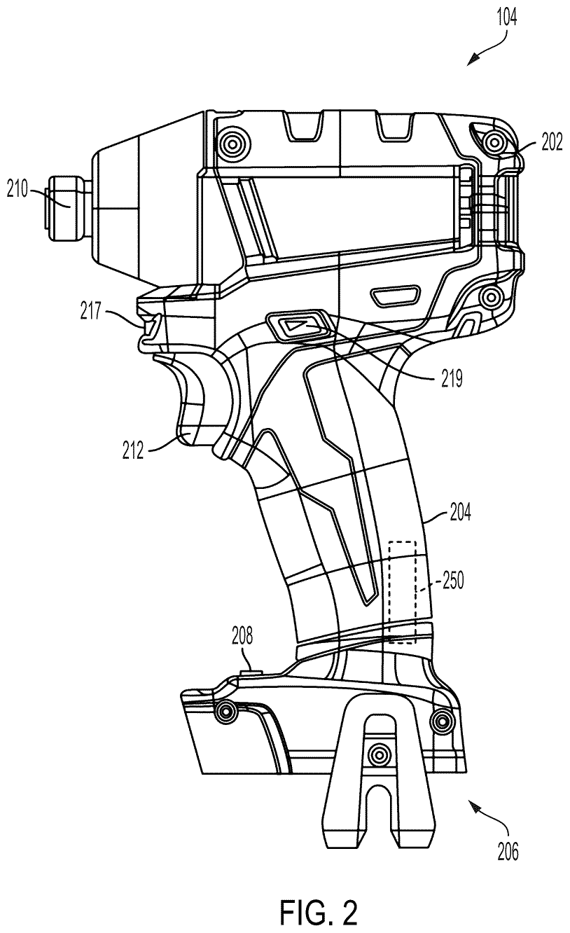

FIG. 2 illustrates an example of the power tool 102a as an impact driver or impact tool 104. The impact tool 104 is representative of various types of power tools that operate within the system 100. Accordingly, the description with respect to the impact tool 104 in the system 100 is similarly applicable to other types of power tools, such as other power tools with impact mechanisms (e.g., impact wrenches and impacting angle drivers) and other power tools. As shown in FIG. 2, the impact tool 104 includes an upper main body 202, a handle 204, a battery pack receiving portion 206, a mode pad 208 an output drive device 210, a trigger 212, a work light 217, and forward/reverse selector 219. The housing of the impact tool 104 (e.g., the main body 202 and the handle 204) may be composed of a durable and light-weight plastic material. The drive device 210 may be composed of a metal (e.g., steel). The drive device 210 on the impact tool 104 is a socket. However, other power tools may have a different drive device 210 specifically designed for the task associated with the other power tool. The battery pack receiving portion 206 is configured to receive and couple to the battery pack (e.g., 102b of FIG. 1) that provides power to the impact tool 104. The battery pack receiving portion 206 includes a connecting structure to engage a mechanism that secures the battery pack and a terminal block to electrically connect the battery pack to the impact tool 104. The mode pad 208 allows a user to select a mode of the impact tool 104 and indicates to the user the currently selected mode of the impact tool 104.

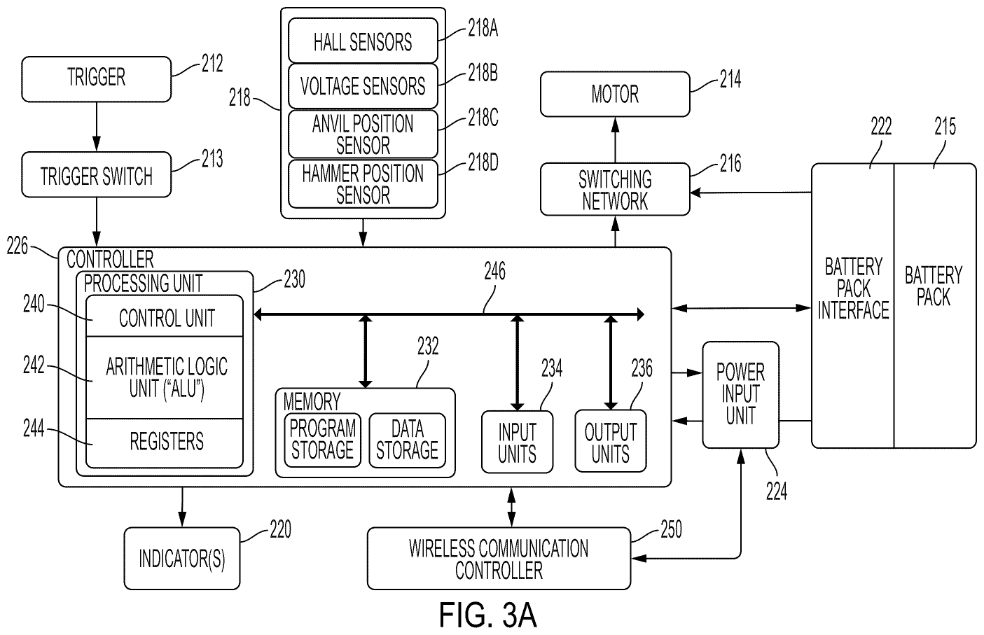

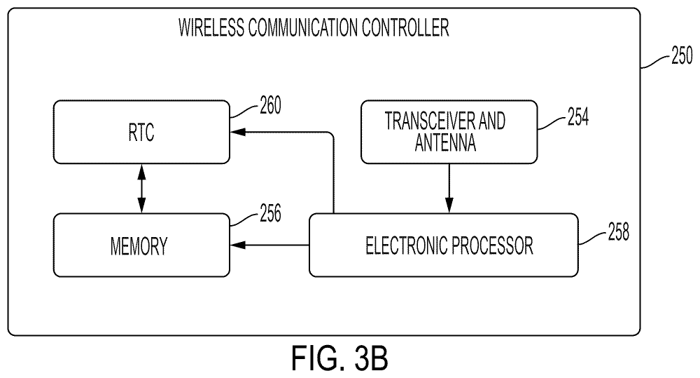

As shown in FIG. 3A, the impact tool 104 also includes a motor 214. The motor 214 actuates the drive device 210 and allows the drive device 210 to perform the particular task. A primary power source (e.g., a battery pack) 215 couples to the impact tool 104 and provides electrical power to energize the motor 214. The motor 214 is energized based on the position of the trigger 212. When the trigger 212 is depressed, the motor 214 is energized, and when the trigger 212 is released, the motor 214 is de-energized. In the illustrated embodiment, the trigger 212 extends partially down a length of the handle 204. However, in other embodiments, the trigger 212 extends down the entire length of the handle 204 or may be positioned elsewhere on the impact tool 104. The trigger 212 is moveably coupled to the handle 204 such that the trigger 212 moves with respect to the tool housing. The trigger 212 is coupled to a push rod, which is engageable with a trigger switch 213 (see FIG. 3A). The trigger 212 moves in a first direction towards the handle 204, when the trigger 212 is depressed by the user. The trigger 212 is biased (e.g., with a spring) such that it moves in a second direction away from the handle 204, when the trigger 212 is released by the user. When the trigger 212 is depressed by the user, the push rod activates the trigger switch 213, and when the trigger 212 is released by the user, the trigger switch 213 is deactivated. In some embodiments, the trigger 212 is coupled to an electrical trigger switch 213. In such embodiments, the trigger switch 213 may include, for example, a transistor. Additionally, for such electrical trigger switch embodiments, the trigger 212 may not include a push rod to activate a mechanical switch. Rather, the electrical trigger switch 213 may be activated by, for example, a position sensor (e.g., a Hall-Effect sensor) that relays information about the relative position of the trigger 212 to the tool housing or electrical trigger switch 213. The trigger switch 213 outputs a signal indicative of the position of the trigger 212. In some instances, the signal is binary and indicates either that the trigger 212 is depressed or released. In other instances, the signal indicates the position of the trigger 212 with more precision. For example, the trigger switch 213 may output an analog signal that various from 0 to 5 volts depending on the extent that the trigger 212 is depressed. For example, 0 V output indicates that the trigger 212 is released, 1 V output indicates that the trigger 212 is 20% depressed, 2 V output indicates that the trigger 212 is 40% depressed, 3 V output indicates that the trigger 212 is 60% depressed, 4 V output indicates that the trigger 212 is 80% depressed, and 5 V indicates that the trigger 212 is 100% depressed. However, these are merely examples and alternative thresholds (and an alternative number of thresholds) may be used to provide different gradients of depression precision. The signal output by the trigger switch 213 may be analog or digital.

As also shown in FIG. 3A, the impact tool 104 also includes a switching network 216, sensors 218, indicators 220, the battery pack interface 222, a power input unit 224, a controller 226, and a wireless communication controller 250. The battery pack interface 222 is coupled to the controller 226 and couples to the battery pack 215. The battery pack interface 222 includes a combination of mechanical (e.g., the battery pack receiving portion 206) and electrical components configured to and operable for interfacing (e.g., mechanically, electrically, and communicatively connecting) the impact tool 104 with the battery pack 215. The battery pack interface 222 is coupled to the power input unit 224. The battery pack interface 222 transmits the power received from the battery pack 215 to the power input unit 224. The power input unit 224 includes active and/or passive components (e.g., voltage step-down controllers, voltage converters, rectifiers, filters, etc.) to regulate or control the power received through the battery pack interface 222 and provided to the wireless communication controller 250 and controller 226.

The switching network 216 enables the controller 226 to control the operation of the motor 214. Generally, when the trigger 212 is depressed as indicated by an output of the trigger switch 213, electrical current is supplied from the battery pack interface 222 to the motor 214, via the switching network 216. When the trigger 212 is not depressed, electrical current is not supplied from the battery pack interface 222 to the motor 214.

In response to the controller 226 receiving the activation signal from the trigger switch 213, the controller 226 activates the switching network 216 to provide power to the motor 214. The switching network 216 controls the amount of current available to the motor 214 and thereby controls the speed and torque output of the motor 214. The switching network 216 may include numerous field-effect transistors (“FETs”), bipolar transistors, or other types of electrical switches. For instance, the switching network 216 may include a six-FET bridge that receives pulse-width modulated (“PWM”) signals from the controller 226 to drive the motor 214.

The sensors 218 are coupled to the controller 226 and communicate to the controller 226 various signals indicative of different parameters of the impact tool 104 or the motor 214. The sensors 218 include one or more Hall sensors 218a, one or more voltage sensors 218b, one or more anvil position sensors 218c (for example, anvil rotation sensors), one or more hammer position sensors 218d (for example, hammer translation sensors), among other sensors, such as, for example, one or more current sensors, one or more temperature sensors, one or more hammer impact sensors, and one or more torque sensors. Each Hall sensor 218a outputs motor feedback information to the controller 226, such as an indication (e.g., a pulse) when a magnet of the motor's rotor rotates across the face of that Hall sensor. Based on the motor feedback information from the Hall sensors 218a, the controller 226 can determine the position, velocity, and acceleration of a rotor of the motor 214. In response to the motor feedback information and the signals from the trigger switch 213, the controller 226 transmits control signals to control the switching network 216 to drive the motor 214. For instance, by selectively enabling and disabling the FETs of the switching network 216, power received via the battery pack interface 222 is selectively applied to stator coils of the motor 214 to cause rotation of its rotor. The motor feedback information is used by the controller 226 to ensure proper timing of control signals to the switching network 216 and, in some instances, to provide closed-loop feedback to control the speed of the motor 214 to be at a desired level. The one or more voltage sensors 218b may provide voltage signals to the controller 226 indicative of a voltage of the battery pack 215.

The indicators 220 are also coupled to the controller 226 and receive control signals from the controller 226 to turn ON and OFF or otherwise convey information based on different states of the impact tool 104. The indicators 220 include, for example, one or more light-emitting diodes (“LEDs”), or a display screen. The indicators 220 can be configured to display conditions of, or information associated with, the impact tool 104. For example, the indicators 220 may be configured to indicate measured electrical characteristics of the impact tool 104, the status of the impact tool 104, the mode of the power tool (e.g., as discussed below), etc. The indicators 220 may also include elements to convey information to a user through audible or tactile outputs.

As described above, the controller 226 is electrically and/or communicatively connected to a variety of modules or components of the impact tool 104. In some embodiments, the controller 226 includes a plurality of electrical and electronic components that provide power, operational control, and protection to the components and modules within the controller 226 and/or impact tool 104. For example, the controller 226 includes, among other things, a processing unit 230 (e.g., a microprocessor, a microcontroller, electronic processor, electronic controller, or another suitable programmable device), a memory 232, input units 234, and output units 236. The processing unit 230 (herein, electronic processor 230) includes, among other things, a control unit 240, an arithmetic logic unit (“ALU”) 242, and a plurality of registers 244 (shown as a group of registers in FIG. 3A). In some embodiments, the controller 226 is implemented partially or entirely on a semiconductor (e.g., a field-programmable gate array [“FPGA”] semiconductor) chip, such as a chip developed through a register transfer level (“RTL”) design process.

The memory 232 includes, for example, a program storage area and a data storage area. The program storage area and the data storage area can include combinations of different types of memory, such as a read-only memory (“ROM”), a random access memory (“RAM”) (e.g., dynamic RAM [“DRAM”], a synchronous DRAM [“SDRAM”], etc.), an electrically erasable programmable read-only memory (“EEPROM”), a flash memory, a hard disk, a secure digital (“SD”) card, or other suitable magnetic, optical, physical, or electronic memory device(s). The electronic processor 230 is connected to the memory 232 and executes software instructions that are stored in a memory 232 (e.g., RAM 232 during execution), a ROM 232 (e.g., on a generally permanent basis), or another non-transitory computer readable medium such as another memory or a disc). Software included in the implementation of the impact tool 104 can be stored in the memory 232 of the controller 226 (e.g., in the program storage area). The software includes, for example, firmware, one or more applications, program data, filters, rules, one or more program modules, and other executable instructions. The controller 226 is configured to retrieve from memory and execute, among other things, instructions related to the control processes and methods described herein. The controller 226 is also configured to store power tool information on the memory 232 including operational data, information identifying the type of tool, a unique identifier for the particular tool, and other information relevant to operating or maintaining the impact tool 104. The tool usage information, such as current levels, motor speed, motor acceleration, motor direction, number of impacts, may be captured or inferred from data output by the sensor(s) 218. Such power tool information may then be accessed by a user with the external device 108. In other constructions, the controller 226 includes additional, fewer, or different components.

The wireless communication controller 250 is coupled to the controller 226. In the illustrated embodiment, the wireless communication controller 250 is located near the foot of the impact tool 104 (see FIG. 2) to save space and ensure that the magnetic activity of the motor 214 does not affect the wireless communication between the impact tool 104 and the external device 108.

As shown in FIG. 3B, the wireless communication controller 250 includes a radio transceiver and an antenna 254, a memory 256, an electronic processor 258, and a real-time clock (“RTC”) 260. The radio transceiver and antenna 254 operate together to send and receive wireless messages to and from, for example, the external device 108 and the electronic processor 258. The memory 256 can store instructions to be implemented by the electronic processor 258 and/or may store data related to communications between the impact tool 104 and the external device 108 or the like. The electronic processor 258 for the wireless communication controller 250 controls wireless communications between the impact tool 104 and the external device 108. For example, the electronic processor 258 associated with the wireless communication controller 250 buffers incoming and/or outgoing data, communicates with the controller 226, and determines the communication protocol and/or settings to use in wireless communications.

In the illustrated embodiment, the wireless communication controller 250 is a Bluetooth® controller. The Bluetooth® controller communicates with the external device 108 employing the Bluetooth® protocol. Therefore, in the illustrated embodiment, the external device 108 and the impact tool 104 are within a communication range (i.e., in proximity) of each other while they exchange data. In other embodiments, the wireless communication controller 250 communicates using other protocols (e.g., Wi-Fi®, cellular protocols, a proprietary protocol, etc.) over a different type of wireless network. For example, the wireless communication controller 250 may be configured to communicate via Wi-Fi® through a WAN, such as the Internet or a LAN, or to communicate through a piconet (e.g., using infrared or near-field communications [“NFC”]). The communication via the wireless communication controller 250 may be encrypted to protect the data exchanged between the impact tool 104 and the external device/network 108 from third parties.

The wireless communication controller 250 is configured to receive data from the power tool controller 226 and relay the information to the external device 108 via the transceiver and antenna 254. In a similar manner, the wireless communication controller 250 is configured to receive information (e.g., configuration and programming information) from the external device 108 via the transceiver and antenna 254 and relay the information to the power tool controller 226.

The RTC 260 increments and keeps time independently of the other power tool components. The RTC 260 receives power from the battery pack 215 when the battery pack 215 is connected to the impact tool 104 and may receive power from the back-up power source (e.g., a coin cell battery) when the battery pack 215 is not connected to the impact tool 104. Having the RTC 260 as an independently powered clock enables time stamping of operational data (stored in memory 232 for later export) and a security feature whereby a lockout time is set by a user and the tool is locked-out when the time of the RTC 260 exceeds the set lockout time.

The memory 232 stores various identifying information of the impact tool 104 including a unique binary identifier (UBID), an American Standard Code for Information Interchange [“ASCII”] serial number, an ASCII nickname, a decimal catalog number, etc. The UBID both uniquely identifies the type of tool and provides a unique serial number for each impact tool 104. Additional or alternative techniques for uniquely identifying the impact tool 104 are used in some embodiments.

FIGS. 4A and 4B show an impact mechanism 400, which is an example of an impact mechanism of the impact tool 104. Based on the design of the impact mechanism 400 of the impact tool 104, the motor 214 rotates at least a predetermined number of degrees between impacts (i.e., 180 degrees for the impact mechanism 400). The impact mechanism 400 includes a hammer 405 with outwardly extending lugs 407 and an anvil 410 with outwardly extending lugs 415. The anvil 410 is coupled to the output drive device 210. In some embodiments, the output drive device 210 includes a gearbox output for interfacing with a gearbox to drive another output shaft. FIGS. 4A and 4B illustrate a helical bevel gearbox output, however, other type of gearbox outputs may be used, such as a straight bevel, a spiral bevel, or the like. In some embodiments, the gearbox output is omitted and the output drive device 210 directly interfaces with a workpiece. For example, the output drive device 210 may be a socket as shown in FIG. 2, a chuck, or some other suitable type of workpiece interface. During operation, impacting occurs when the anvil 410 encounters a certain amount of resistance, e.g., when driving a fastener into a workpiece. When this resistance is met, the hammer 405 continues to rotate. A spring coupled to the back-side of the hammer 405 causes the hammer 405 to disengage the anvil 410 by axially retreating. Once disengaged, the hammer 405 will advance both axially and rotationally to again engage (i.e., impact) the anvil 410. When the impact mechanism 400 is operated, the hammer lugs 407 impact the anvil lugs 415 every 180 degrees. Accordingly, when the impact tool 104 is impacting, the hammer 405 rotates 180 degrees without the anvil 410, impacts the anvil 410, and then rotates with the anvil 410 a certain amount before repeating this process. For further reference on the functionality of the impact mechanism 400, see, for instance, the impact mechanism discussed in U.S. patent application Ser. No. 14/210,812, filed Mar. 14, 2014, the entire content of which is hereby incorporated by reference. Although two hammer lugs 407 that impact the anvil lugs 415 every 180 degrees are shown, more than two hammer lugs 407 could be used, which would change the degrees of separation (e.g., three hammer lugs that impact the anvil lugs 415 every 120 degrees), according to various embodiments.

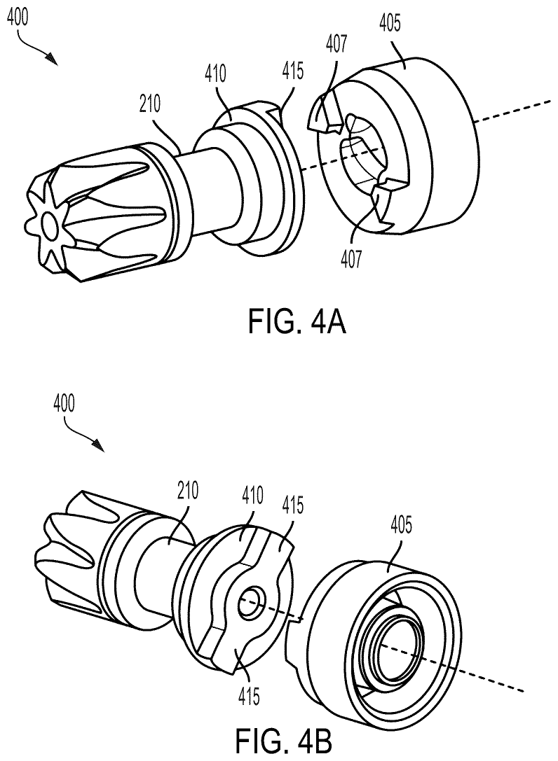

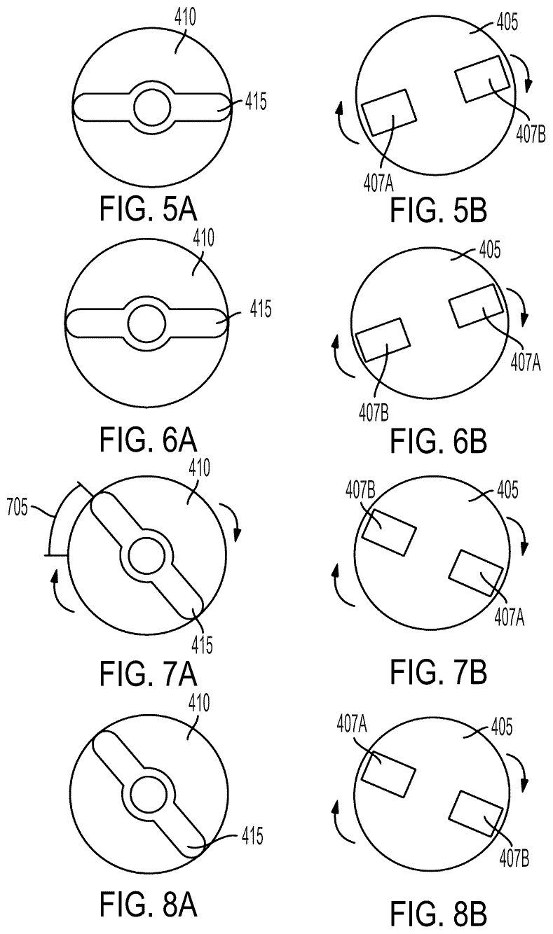

The controller 226 can determine how far the hammer 405 and the anvil 410 rotated together by monitoring the angle of rotation of the shaft of the motor 214 between impacts using one or more of the Hall sensors 218a, by monitoring the anvil position using the anvil position sensor 218c, by monitoring the hammer position using the hammer position sensor 218d, or a combination thereof. For example, when the impact tool 104 is driving an anchor into a softer joint, the hammer 405 may rotate 225 degrees between impacts. In this example of 225 degrees, 45 degrees of the rotation includes hammer 405 and anvil 410 engaged with each other and 180 degrees includes just the hammer 405 rotating before the hammer lugs 407 impact the anvil 410 again. FIGS. 5-8 illustrate this exemplary rotation of the hammer 405 and the anvil 410 at different stages of operation.

FIGS. 5A and 5B show the rotational positions of the anvil 410 and the hammer 405, respectively, at a first timing (e.g., just after the hammer lugs 407A, 407B disengage the lugs 415 of the anvil 410 [i.e., after an impact and engaged rotation by both the hammer 405 and the anvil 410 has occurred]). FIG. 5A shows a first rotational anvil position of the anvil 410 at the first timing. FIG. 5B shows a first rotational hammer position of the hammer 405 at the first timing (e.g., just as the hammer lugs 407A and 407B begin to axially retreat from the anvil 410). After the hammer 405 disengages the anvil 410 by axially retreating, the hammer 405 continues to rotate (as indicated by the arrows in FIG. 5B) while the anvil 410 remains in the first rotational anvil position. FIGS. 6A and 6B show the rotational positions of the anvil 410 and the hammer 405, respectively, at a second timing (e.g., at a first moment of impact). As shown in FIG. 6A, the anvil 410 remains in the first rotational anvil position at the second timing. As shown in FIG. 6B, the hammer 405 has rotated 180 degrees to a second rotational hammer position (as indicated by the arrows in FIG. 6B, and the change of positions of hammer lugs 407A and 407B from FIG. 5B to FIG. 6B).

Upon impact between the hammer lugs 407A and 407B and the anvil lugs 415, the hammer 405 and the anvil 410 rotate together in the same rotational direction (as indicated by the arrows in FIGS. 7A and 7B) which generates torque that is provided to the output drive device 210 to drive an anchor into concrete, for example. FIGS. 7A and 7B show the rotational positions of the anvil 410 and the hammer 405, respectively, at a third timing (e.g., after the hammer 405 again disengages the anvil 410 by axially retreating). As an example, in FIGS. 7A and 7B, at a third timing, the hammer 405 is in a third rotational hammer position and the anvil 410 is in a second rotational anvil position that is approximately 45 degrees from the first rotational anvil position as indicated by drive angle 705. The drive angle 705 indicates the number of degrees that the anvil 410 rotated between events (e.g., between non-movement periods or between impacts) which corresponds to the number of degrees that the output drive device 210 rotated between events.

As stated above, after the hammer 405 disengages the anvil 410, the hammer 405 continues to rotate (as indicated by the arrows in FIG. 8B) while the anvil 410 remains in the same rotational position. FIGS. 8A and 8B show the rotational positions of the anvil 410 and the hammer 405, respectively, at a fourth timing (e.g., a second moment of impact is occurring). As shown in FIG. 8A, the anvil 410 remains in the second rotational anvil position at the fourth timing. As shown in FIG. 8B, the hammer 405 has rotated 180 degrees from the third rotational hammer position to a fourth rotational hammer position. Relative to FIG. 6B (i.e., the first timing (e.g., when the first moment of impact occurred)), the hammer 405 has rotated 225 degrees (i.e., 45 degrees while engaged with the anvil 410 after the previous impact and 180 degrees after disengaging from the anvil 410). Although specific degrees of rotation are used for exemplary purposes above, it can be appreciated that the specific degrees of rotation may vary.

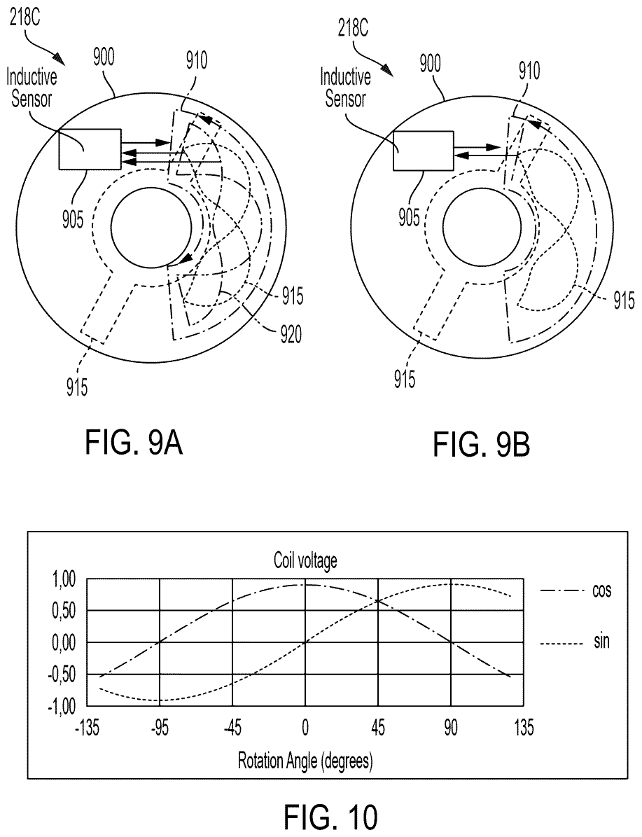

FIG. 9A illustrates the anvil position sensor 218c of the power tool 102. The anvil position sensor 218c includes a printed circuit board 900 supporting or associated with an inductive sensor 905, a transmitting circuit trace 910, a first receiving circuit trace 915, and a second receiving circuit trace 920. The inductive sensor 905 injects a current into the transmitting circuit trace 910 to generate a magnetic field. As seen in FIG. 4B, the anvil 410 includes lugs 415 that are engaged by the lugs 407 on the hammer 405 to rotate the anvil 410. As the anvil 410 rotates, the lugs 415 pass through the magnetic field generated by the injection of the signal into the transmitting circuit trace 910. Eddy currents are generated in the lugs 415 of the anvil 410. The eddy currents generate a magnetic field that passes across the receiving circuit traces 915, 920. Current induced in the receiving circuit traces 915, 920 is used by the inductive sensor 905 to determine the position of the anvil lug 415 with respect to the receiving circuit traces 915, 920.

In some embodiments, the receiving circuit traces 915, 920 are sinusoidal in shape but offset by 90°, so that when the anvil 410 rotates, the voltage in one of the receiving circuit traces 915, 920 is a sine wave and the voltage in the other receiving circuit trace 915, 920 is a cosine wave. The voltage output of the two receiving traces 915, 920 can then be used by the controller 226 to determine the location (e.g., rotational angle) of the anvil 410 with respect to the receiving circuit traces. In some embodiments, the angle is generated by the controller 226 using an arctangent function,

$$a = arctan \frac{{V}_{sin}}{{V}_{cos}} .$$

In some embodiments, the anvil position sensor 218c achieves a resolution of approximately 0.15° for detection of the position of the anvil lug 415 and has a detection accuracy of greater than 98%.

In some instances, the hammer position sensor 218d has a similar or the same design as the anvil position sensor 218c. For example, the hammer position sensor 218d includes the printed circuit board 900 supporting or associated with the inductive sensor 905, the transmitting circuit trace 910, the first receiving circuit trace 915, and the second receiving circuit trace 920. As the hammer 405 advances axially and rotationally to engage the anvil 410, the hammer lugs 407 pass through the magnetic field generated by the injection of the signal into the transmitting circuit trace 910. Eddy currents are generated in the hammer lugs 407 and generate a magnetic field that passes across the receiving circuit traces 915, 920. Current induced in the receiving circuit traces 915, 920 is used by the inductive sensor 905 to determine the position of the hammer lug 407 with respect to the receiving circuit traces 915, 920. In some embodiments, the hammer position sensor 218d is configured in a straight line for detecting the translational movement of the hammer 405 (e.g., as opposed to being curved like the anvil position sensor 218c), and the printed circuit board can be rectangular rather than circular.

FIG. 10 illustrates the output of the anvil sensor of FIG. 9A as a function of an anvil rotation angle. In the embodiment illustrated in FIG. 9A, the printed circuit board 900 includes approximately 180° of traces (e.g., across approximately half of the circumference of the printed circuit board 900). In other embodiments, the traces for transmitting and receiving extend across approximately the entire surface of the printed circuit board 900 (e.g., approximately 360° around the circumference of the printed circuit board 900). In some embodiments, a target length (e.g., anvil lug 415) is approximately 20-50% of the receiving circuit trace 915, 920's period length.

In some embodiments, the anvil position sensor 218c includes a single receiving circuit trace 915, as shown in FIG. 9B. The use of a single receiving circuit trace 915 reduces the footprint of the printed circuit board 900. In some embodiments, the controller 226 uses an arc-trigonometric function to resolve angle, but the output of the anvil position sensor 218c is non-linear. The use of two receiving circuit traces 915 and 920 increases robustness to air-gap and interference of neighboring components.

The radial span of the circuit traces 910, 915, 920 on the printed circuit board 900 may vary depending on the configuration of the anvil 410. For an anvil 410 with two lugs 415, the span may be about 180 degrees, since the second lug 415 enters the span covered by the circuit traces 910, 915, 920 as the first lug 415 leaves. Thus, the first lug 415 interfaces with the anvil position sensor 218c during a first portion of the rotation path of the anvil 410, and the second lug 415 interfaces with the anvil position sensor 218c during a second portion of the rotation path of the anvil 410. If more lugs 415 are present, a smaller span for the anvil position sensor 218c may be used.

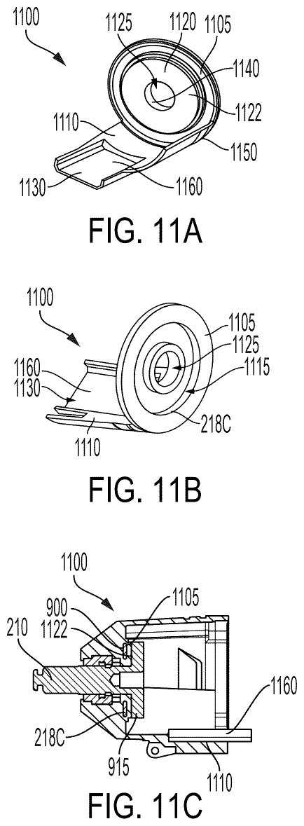

FIGS. 11A-11C illustrate a body portion 1100 of the power tool 102 positioned near the anvil 410 for supporting the anvil position sensor 218c. The body portion 1100 includes a ring portion 1105 and a tray portion 1110 extending from the ring portion 1105. The ring portion 1105 defines a first recess 1115 for receiving the printed circuit board 900 shown in FIGS. 9A and 9B, a thrust support surface 1120 of an anvil thrust support 1122, and an opening 1125. The drive device 210 extends through the opening 1125, and the thrust support surface engages the anvil 410 during operation. The opening 1125 may provide a clearance 1140. A wire routing 1150 may be provided on an outer diameter of a boat between the boat and the gear case inner diameter. The tray portion 1110 defines a second recess 1130 in which a hammer impact sensor 1160 (e.g., hammer impact sensor 218d) may be mounted. As described above, the hammer impact sensor 1160 detects an impact between the hammer 405 and the anvil 410. For example, a hammer impact sensor 1160 may measure axial position, acceleration, sound, or vibration to detect an impact.

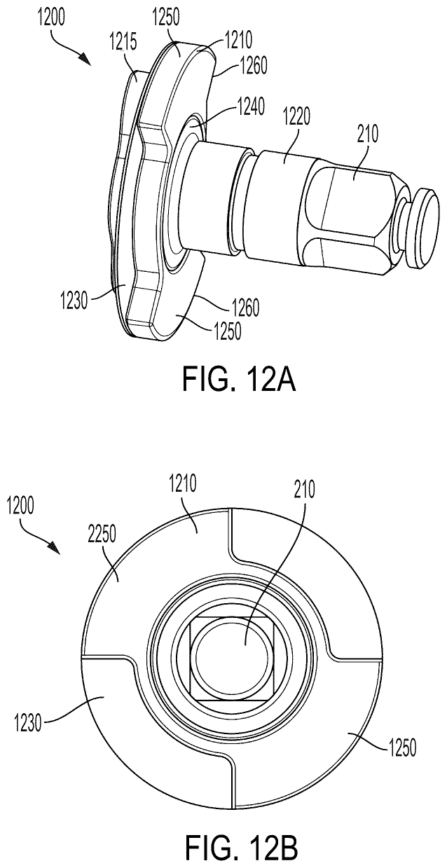

FIGS. 12A and 12B illustrate an embodiment of an anvil assembly 1200 including a target 1210 positioned on a shaft 1220 of the output drive device 210 and a magnetic shield 1230 positioned between the target 1210 and the anvil lugs 415. The magnetic shield 1230 is, for example, made of a material having a magnetic permeability that is greater than air (e.g., greater than 1.26×10⁻⁶ Henries/meter [“H/m”]). In some embodiments, the magnetic shield 1230 is made of a material having a magnetic permeability that is greater than 1×10⁻⁴ H/m. In some embodiments, the magnetic shield 1230 is made of carbon steel. In other embodiments, the magnetic shield 1230 is made of ferrite or another suitable magnetic material. In some embodiments, the target 1210 is a ring member that is mounted on the shaft 1220, such as on an outward projection 1240 of the shaft 1220. In some embodiments, the target 1210 is secured via interference fit or via adhesive. The target 1210 includes target lugs 1250 with radial surfaces 1260 for interfacing with the anvil position sensor 218C.

Referring to FIG. 12A, the radial surfaces 1260 of the target lugs 1250 are positioned adjacent the anvil position sensor 218C. The magnetic shield 1230 magnetically isolates the target lugs 1250 from the anvil lugs 415 and the hammer lugs 407A, 407B to mitigate magnetic interference caused by the positioning of the hammer lugs 407A, 407B proximate the anvil lugs 415 during impact and rotation. The radial span of the circuit traces 910, 915, 920 on the printed circuit board 900 may vary depending on the configuration of the target 1210 and the target lugs 1250. For a target 1210 with two target lugs 1250, the span can be about 180 degrees, since the second target lug 1250 enters the span covered by the circuit traces 910, 915, 920 as the first target lug 1250 leaves. Thus, the first target lug 1250 interfaces with the anvil position sensor 218c during a first portion of the rotation path of the anvil 410, and the second target lug 1250 interfaces with the anvil position sensor 218c during a second portion of the rotation path of the anvil 410. If more target lugs 1250 are present, a smaller span for the anvil position sensor 218c may be used. In other embodiments, a sensor span of between 180 degrees and 360 degrees is used.

The anvil may be unshielded (without a shield) or shielded (e.g., with the 1230 of FIGS. 12A and 12B). The sensor output of the unshielded anvil may provide a less robust signal for determining position compared to the shielded anvil. For example, when the hammer is at a rest position against the anvil, the shielded design provides a more robust signal (e.g., greater signal strength, greater signal to noise ratio, etc.) than the unshielded design. The output of the sensor has a relationship to the anvil position (degrees). The shielded sensor output may be, for example, 99% accurate to ideal performance.

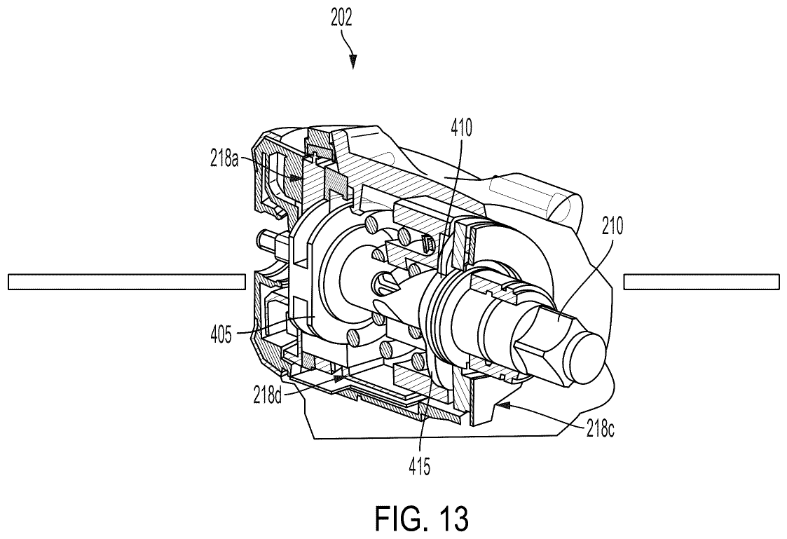

FIG. 13 illustrates a perspective view of the upper housing portion 202 with a portion of the housing removed. The anvil position sensor 218c is positioned adjacent to the anvil 410 and, particularly, the anvil lugs 415. In some instances, the anvil position sensor 218c is positioned below the anvil 410. Similarly, the hammer position sensor 218d is positioned adjacent to the hammer 405 and, particularly, the hammer lugs 407 (see FIG. 4A). In some instances, the hammer position sensor 218d is positioned below the hammer 405. In some implementations, the anvil position sensor 218c and the hammer position sensor 218d share wiring such that signals from the anvil position sensor 218c travel through a circuit board associated with the hammer position sensor 218d, which reduces wiring complexity.

The controller 226 may analyze the anvil position signals (e.g., anvil rotation signals) from the anvil position sensor 218c and hammer position signals (e.g., hammer translation signals) from the hammer position sensor 218d to determine an estimated torque output of the impact tool 104. For example, embodiments described herein utilize a machine learning model, a physics model, or a combination thereof to determine a torque output of the impact tool 104. The machine learning model and/or the physics model receive the anvil position signals and the hammer position signals to determine the output torque. In some instances, a voltage of the battery pack 215 may also be provided to the models or as a supplement to the models to account for variations in battery pack voltage. The estimated torque output provided by the models may then be used by the controller 226 to, for example, control current provide to the motor 214, determine a condition of fasteners, a type of fastener driven by the impact tool 104, and the like.

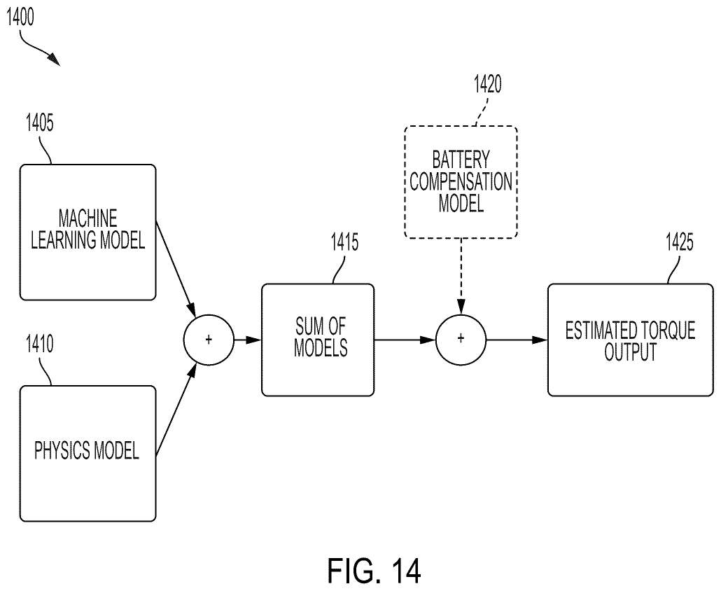

FIG. 14 illustrates a block diagram of an example workflow 1400 of the controller 226. The workflow 1400 includes a machine learning model 1405 and a physics model 1410. The machine learning model 1405 and the physics model 1410 may be stored within the memory 232 of the impact tool 104, stored within the server 112, or the like. An output of the machine learning model 1405 and an output of the physics model 1410 are combined (e.g., summed) to form a sum of models 1415. In some instances, the sum of models 1415 is the final output of the workflow 1400. In other instances, the workflow 1400 further includes a battery compensation model 1420 that analyzes the voltage of the battery pack 215. The output of the battery compensation model 1420 is combined with the sum of models 1415 to generate the estimated torque output 1425.

To implement the machine learning model 1405, the controller 226 is configured to learn a general rule or model that maps the inputs to the outputs based on the provided example input-output pairs. The machine learning algorithm may be configured to perform machine learning using various types of methods. For example, the controller 226 may implement the machine learning program using decision tree learning (such as random decision forests), associates rule learning, artificial neural networks, recurrent artificial neural networks, long short term memory neural networks, inductive logic programming, support vector machines, clustering, Bayesian networks, reinforcement learning, representation learning, similarity and metric learning, sparse dictionary learning, genetic algorithms, k-nearest neighbor (KNN), among others, such as those listed in Table 1 below. In some instances, the machine learning model 1405 is implemented by the server 112 or a combination of the server 112 and the controller 226.

TABLE 1

| | |
|---|---|
| Recurrent | Recurrent Neural Networks [“RNNs”], Long Short-Term Memory |
| Models | [“LSTM”] models, Gated Recurrent Unit [“GRU”] models, Markov |
| | Processes, Reinforcement learning |
| Non-Recurrent | Deep Neural Network [“DNN”], Convolutional Neural Network [“CNN”], |
| Models | Support Vector Machines [“SVM”], Anomaly detection (ex: Principle |
| | Component Analysis [“PCA”]), logistic regression, decision trees/forests, |
| | ensemble methods (combining models), polynomial/Bayesian/other |
| | regressions, Stochastic Gradient Descent [“SGD”], Linear Discriminant |
| | Analysis [“LDA”], Quadratic Discriminant Analysis [“QDA”], Nearest |
| | neighbors classifications/regression, naïve Bayes, attention networks, |
| | transformer networks, etc. |

The controller 226 is programmed and trained to perform a particular task using the machine learning model 1405. For example, in some embodiments, the controller 226 is trained to estimate an output torque of the impact tool 104, a condition of a fastener driven by the impact tool 104, or the like. The training examples used to train the machine learning controller 630 may be graphs or tables of torque profiles. The training examples may be previously collected training examples, from, for example, a plurality of the same type of power tools. For example, the training examples may have been previously collected from a plurality of power tools of the same type (e.g., impact drivers) over a span of, for example, one year. A user may perform an initial calibration of the impact tool 104 implementing the machine learning model 1405 and the physics model 1410, as described below in more detail.

A plurality of different training examples is provided to the controller 226. The controller 226 uses these training examples to generate the machine learning model 1405 (e.g., a rule, a set of equations, and the like) that helps categorize or estimate the output based on new input data. The controller 226 may weight different training examples differently to, for example, prioritize different conditions or inputs and outputs to and from the controller 226. For example, certain observed operating characteristics may be weighed more heavily than others.

In one example, the controller 226 implements an artificial neural network. The artificial neural network includes an input layer, a plurality of hidden layers or nodes, and an output layer. Typically, the input layer includes as many nodes as inputs provided to the controller 226. The number (and the type) of inputs provided to the machine controller 226 may vary based on the particular task for the controller 226. Accordingly, the input layer of the artificial neural network of the controller 226 may have a different number of nodes based on the particular task for the controller 226. The input layer connects to the hidden layers. The number of hidden layers varies and may depend on the particular task for the controller 226. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. However, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is associated with an activation function. The activation function defines how the hidden layer is to process the input received from the input layer or from a previous input layer. These activation functions may vary and be based on not only the type of task associated with the controller 226, but may also vary based on the specific type of hidden layer implemented.

Each hidden layer may perform a different function. For example, some hidden layers can be convolutional hidden layers which can, in some instances, reduce the dimensionality of the inputs, while other hidden layers can perform statistical functions such as max pooling, which may reduce a group of inputs to the maximum value, an averaging layer, among others. In some of the hidden layers (also referred to as “dense layers”), each node is connected to each node of the next hidden layer. Some neural networks including more than, for example, three hidden layers may be considered deep neural networks. The last hidden layer is connected to the output layer. Similar to the input layer, the output layer typically has the same number of nodes as the possible outputs.

During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until a training condition is met. The training condition may correspond to, for example, a predetermined number of training examples being used, a minimum accuracy threshold being reached during training and validation, a predetermined number of validation iterations being completed, and the like. Different types of training algorithms can be used to adjust the bias values and the weights of the node connection based on the training examples. The training algorithms may include, for example, gradient descent, newton's method, conjugate gradient, quasi newton, and levenberg marquardt, among others.

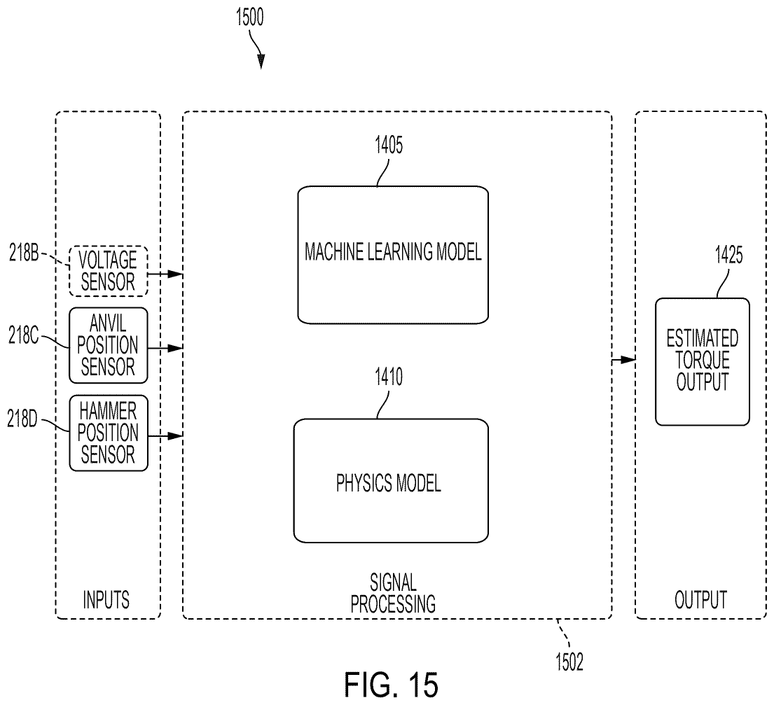

FIG. 15 illustrates a block diagram of another example workflow 1500 of the controller 226. The workflow 1500 illustrates example inputs received by the machine learning model 1405 and/or the physics model 1410. The machine learning model 1405 and the physics model 1410 may be implemented by the controller 226. In the example workflow 1500, the machine learning model 1405 and the physics model 1410 are represented as a signal processing block 1502. For example, the workflow 1500 includes a signal processing block 1502 receiving the anvil position signal from the anvil position sensor 218c and the hammer position signal from the hammer position sensor 218d. In some implementations, the signal processing block 1502 further receives the voltage of the battery pack 215 from the voltage sensor 218b.

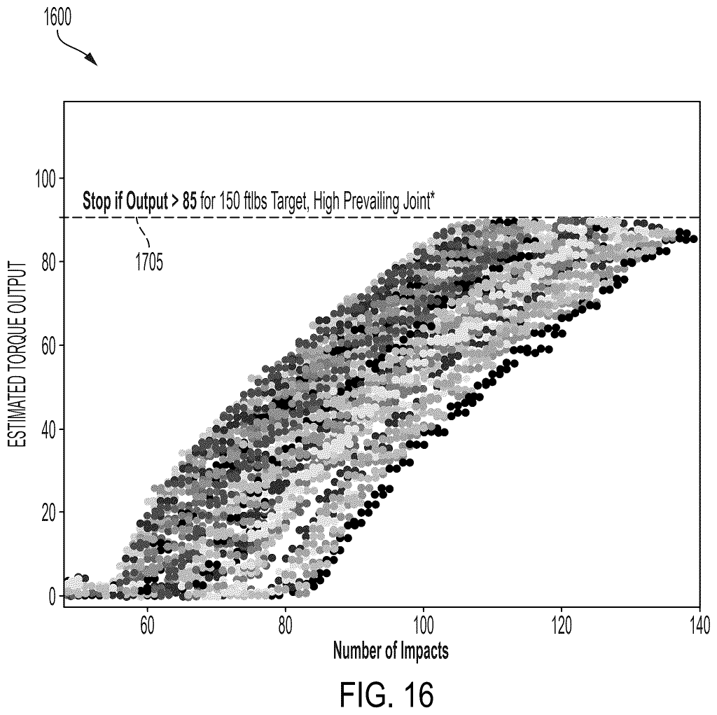

The machine learning model 1405 and/or the physics model 1410 process the anvil position signal, the hammer position signal, and/or the voltage of the battery pack 215 to generate the estimated torque output 1425. In some embodiments, the estimated torque output 1425 is used by the controller 226 for controlling the motor 214. For example, should the estimated torque output 1425 be greater than or equal to a torque threshold, the controller 226 may perform a safety operation. The safety operation may include, for example, reducing the motor current or stopping operation of the motor 214. FIG. 16 provides an example graph 1600 illustrating estimated torque outputs over a given impact count range. Once the estimated torque output exceeds torque threshold 1605, the controller 226 stops operation of the motor 214. As described in greater detail below, the torque threshold can correspond to an internal torque prediction value (e.g., arbitrarily set to a value of between 0 and 100). When the internal torque prediction value that is determined using the models as set forth above, the desired target torque has been reached and the impact tool 104 can be turned off (e.g., to be ready for the next operation).

In some embodiments, the estimated torque output 1425 is used to determine characteristics of a fastener driven by the impact tool 104. For example, the controller 226 may determine fastener diameter (e.g., thickness), fastener condition, fastener type, and the like, using the estimated torque output 1425. To determine fastener characteristics, the controller 226 may compare the outputs of the physics model 1410 and/or the machine learning model 1405 to known fastener characteristic graphs.

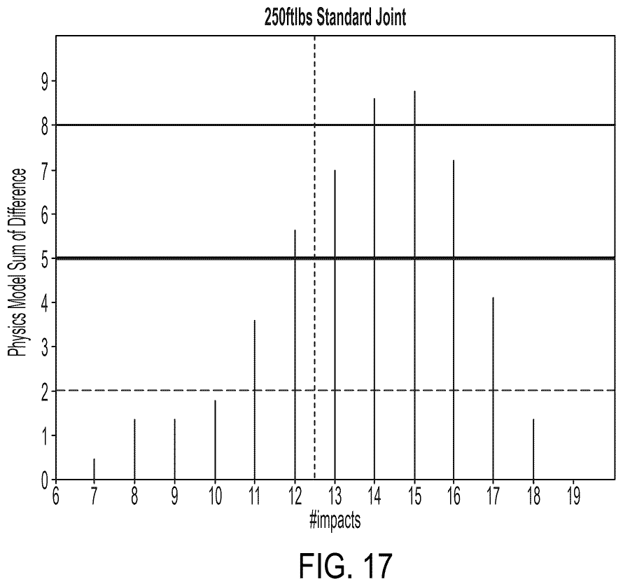

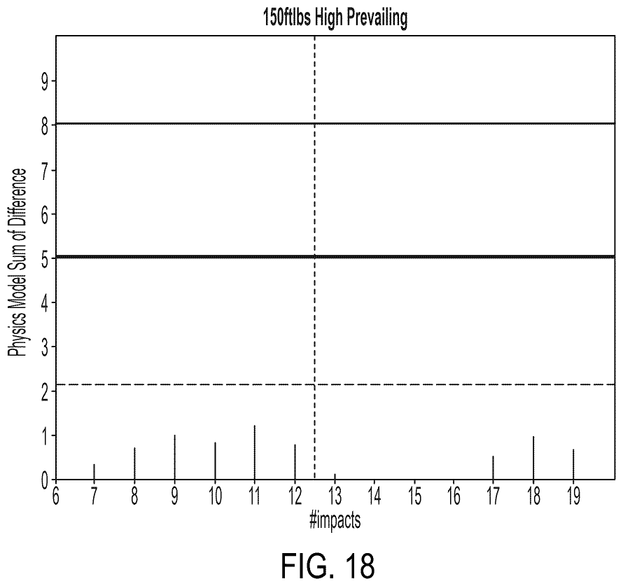

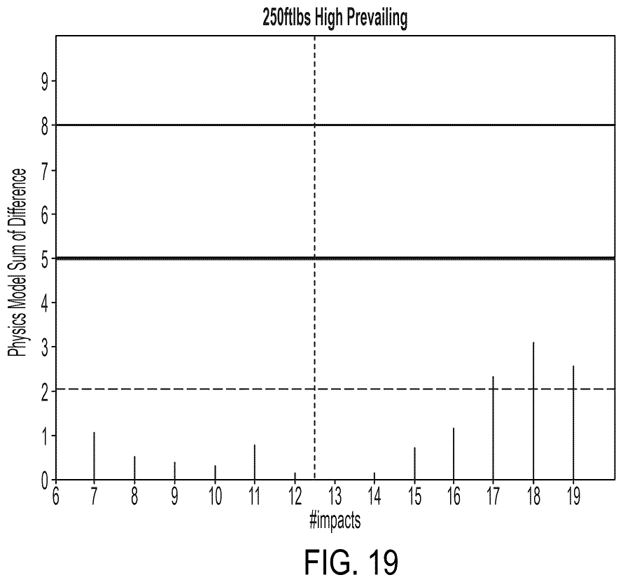

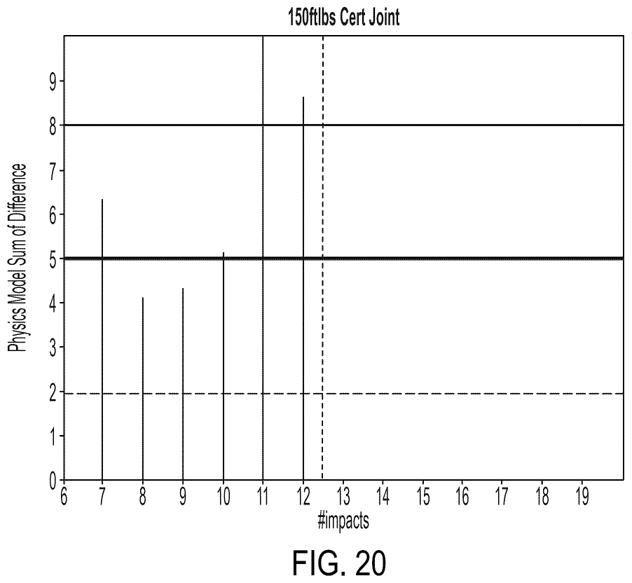

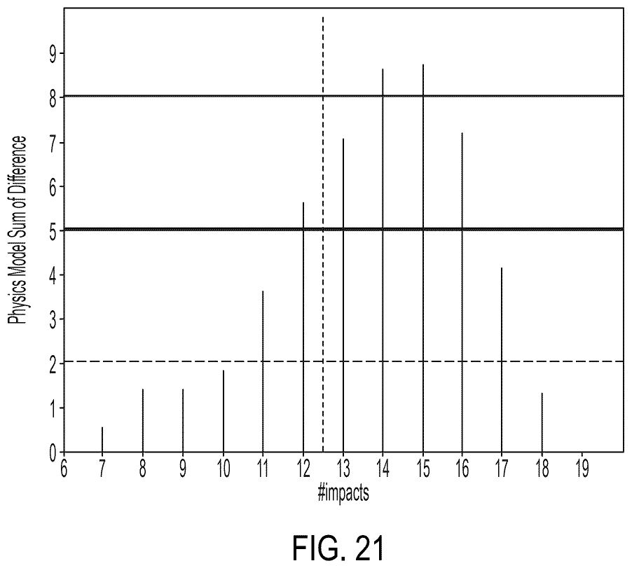

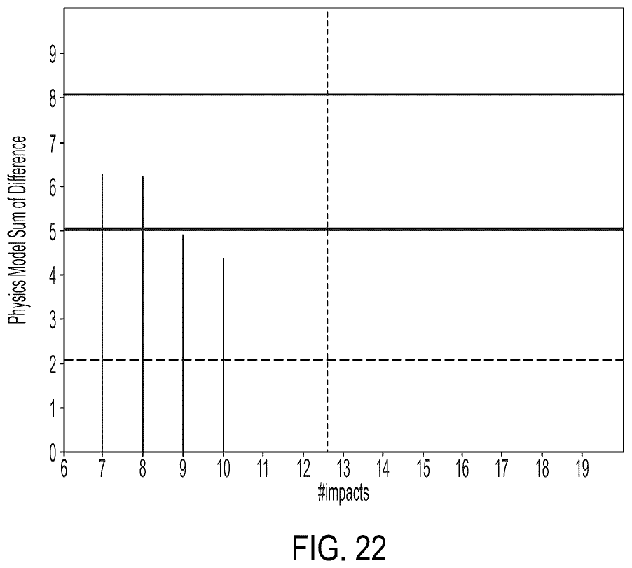

For example, FIGS. 17-22 illustrate outputs of the physics model for a given number of impacts and for various fastener types. FIG. 17 illustrates a characteristic graph for a 250 ftlbs standard joint. FIG. 18 illustrates a characteristic graph for a 150 ftlbs high prevailing joint. FIG. 19 illustrates a characteristic graph for a 250 ftlbs high prevailing joint. FIG. 20 illustrates a characteristic graph for a 150 ftlbs cert joint. FIG. 21 illustrates a characteristic graph of a 0.75 inch, 250 ftlbs standard joint bolt. FIG. 22 illustrates a characteristic graph of a 0.5 inch, 50 ftlbs standard joint bolt. The characteristic graphs may be stored in the memory 232.

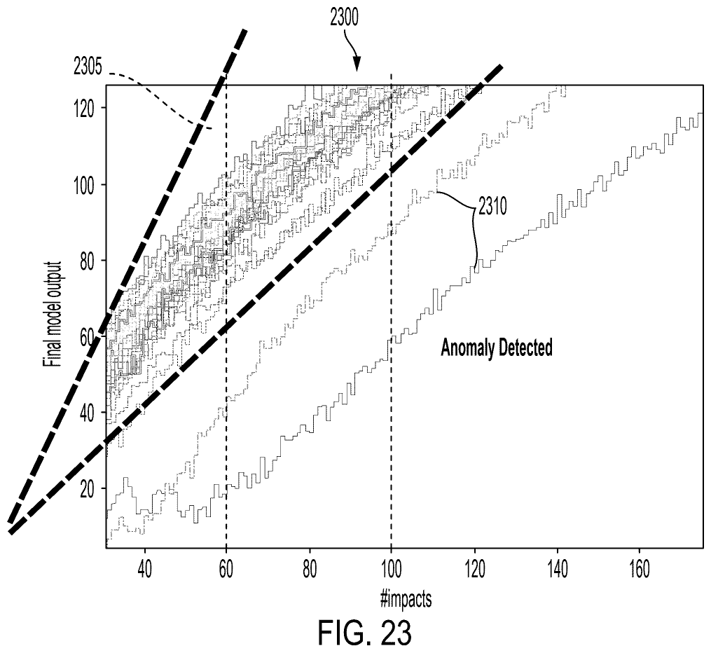

In some instances, within a certain number of impacts, the final model output by the machine learning model 1405, the physics model 1410, or a combination thereof is not within expected range for one of the characteristic graphs. In such an instance, the controller 226 may determine that the condition of the fastener is unacceptable (e.g., the fastener is degraded, distorted, or the like). FIG. 23 illustrates an example graph 2300 illustrating a plurality of model outputs over a plurality of impacts. A majority of the model outputs fall within an expected output range 2305. Two outlier outputs 2310 do not fall within the expected output range 2305 after a predetermined number of impacts (e.g., 100 impacts in the example of FIG. 23), and are identified as anomalies by the controller 226.

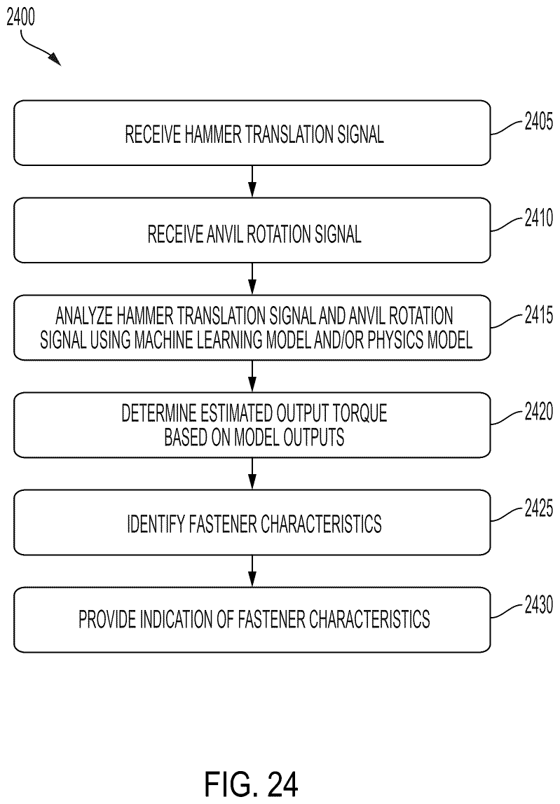

FIG. 24 illustrates a method 2400 performed by the controller 226. At block 2405, the controller 226 receives a hammer translation signal. For example, the controller 226 receives a hammer position signal from the hammer position sensor 218d. At block 2410, the controller 226 receives an anvil rotation signal. For example, the controller 226 receives an anvil position signal from the anvil position sensor 218c. At block 2415, the controller 226 analyzes the hammer translation signal and the anvil rotation signal using the machine learning model and/or the physics model, as previously described with respect to FIGS. 14-15.

At block 2420, the controller 226 determines an estimated output torque based on model outputs from the machine learning model and/or the physics model. For example, with reference to FIG. 14, the controller 226 determines the estimated torque output 1425. At block 2425, the controller 226 identifies fastener characteristics based on the estimated output torque. For example, the controller 226 compares the estimated output torque over a plurality of impact counts to characteristic graphs stored in the memory 232.

At block 2430, the controller 226 provides an indication of the fastener characteristics. For example, the controller 226 may transmit the identified fastener characteristics to the external device 108. The external device 108 is configured to display the fastener characteristics. In some instances, the external device 108 generates a report detailing the fastener characteristics.

In some instances, the impact tool 104 is calibrated to set an internal torque prediction value that corresponds to a desired target torque output value of the power tool. For example, an external tool, such as a torque wrench, may be used to confirm the torque output of the impact tool 104. Over the course of a predetermined number of impact operations (for example, 10 operations), an operator uses the torque wrench to provide feedback to the impact tool 104. The feedback may be provided via the external device 108 or by an input device of the impact tool 104 (for example, a user interface).

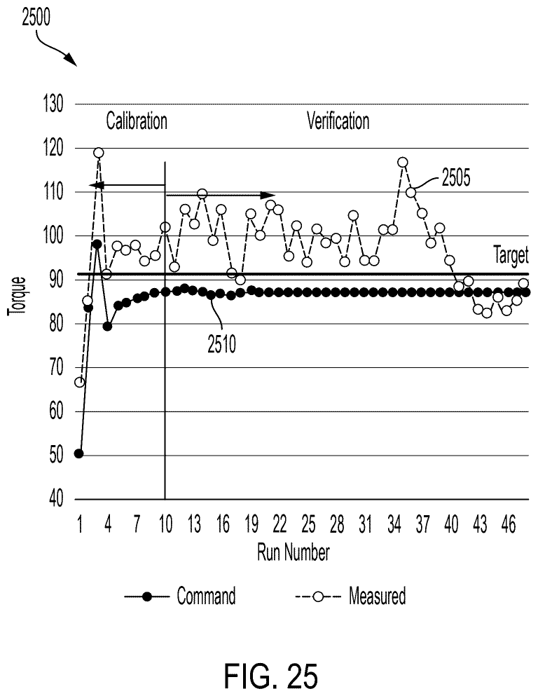

FIG. 25 provides an example graph 2500 illustrating calibration of the impact tool 104. The graph 2500 includes measured torque values 2505 and commanded torque values 2510. The measured torque values 2505 may be measured, for example, using a torque wrench. During a plurality of runs, the impact tool 104 attempts to identify an internal torque prediction value. The internal torque prediction value can have a value of, for example, between 0 and 100. The internal torque prediction value is set to an initial value (e.g., 30, 40, 50, 60, and the like). Then for each run, the internal torque prediction value is modified based on the difference between the target torque value and the actual measured torque value. After, for example, ten runs, the internal torque prediction value will sufficiently accurately represent the target torque value (e.g., +/−10%, 12%, 15%, and the like). In the example of FIG. 25, the target torque value is approximately 90 ftlbs. The measured torque values 2505 fluctuate as the impact tool 104 adjusts the internal torque prediction value to attempt to match the commanded torque values 2510 to the target torque value. A torque wrench may be used to determine an error between the commanded torque value 2510 and the actual torque value applied by the impact tool 104 for a given internal torque prediction value.

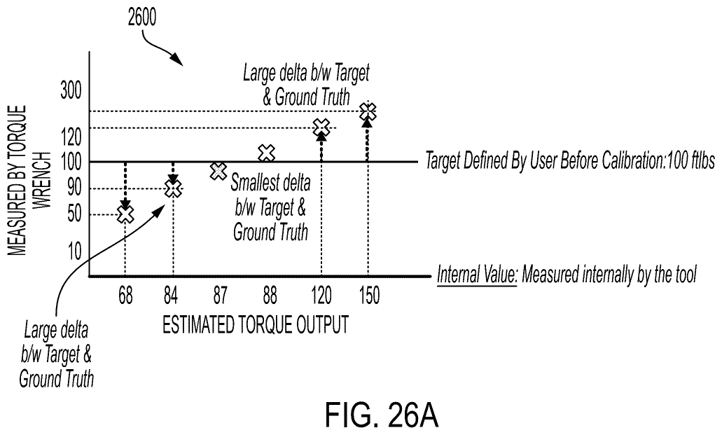

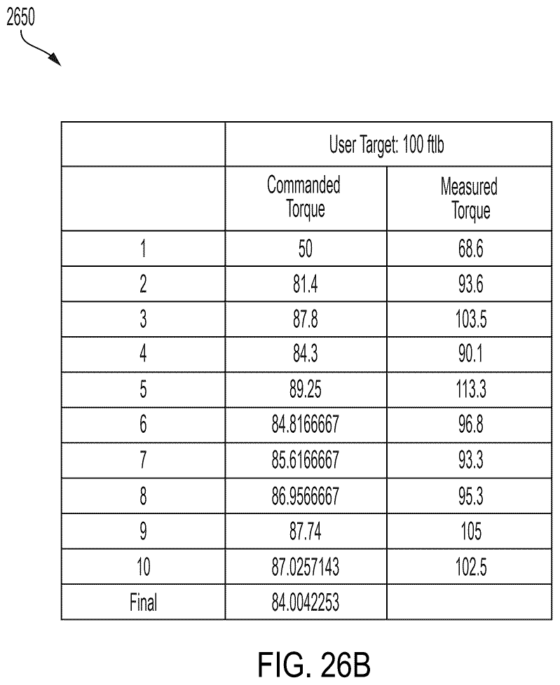

FIGS. 26A-26B illustrate the calibration of the impact tool 104 in greater detail. FIG. 26A provides a graph 2600 comparing the estimated torque output 1425 to the actual torque measured by the impact wrench. The estimated torque output 1425 corresponds to the internal torque prediction value (e.g., between 0 and 100). FIG. 26B provides a table 2650 comparing the actual torque measured by the impact wrench to the commanded torque value (i.e., internal torque prediction value) for a real-world target torque of 100 ftlbs. When a difference between the commanded torque and the actual torque measured by the impact wrench is negative, the estimated torque output 1425 is increased. When the difference between the target torque and the actual torque is positive, the estimated torque output 1425 is decreased. This process is repeated until the difference between the commanded torque and the actual torque is within an acceptable range (e.g., within +/−10%, 12%, 15%, and the like). In the illustrated embodiment of FIG. 26B, an internal torque prediction value of 84 corresponds to the real-world target torque of 100 ftlbs. Once the impact tool 104 is calibrated, the calibrated setting for the internal torque prediction value can be saved to memory (e.g., memory 232). In some embodiments, the internal torque prediction value for a given application can be stored as a mode for the impact tool 104 that can be selected by a user. As a result, the impact tool 104 could have multiple internal torque prediction values saved for multiple different applications. The user can select among the internal torque prediction values by selected the corresponding mode (e.g., via a mode button). In some embodiments, the calibration settings may be provided to other power tools 102 over the network 114 or tool-to-tool using a short-range wireless or wired communication, removing the need to calibrate multiple of the same tool (e.g., that are being used for the same application.

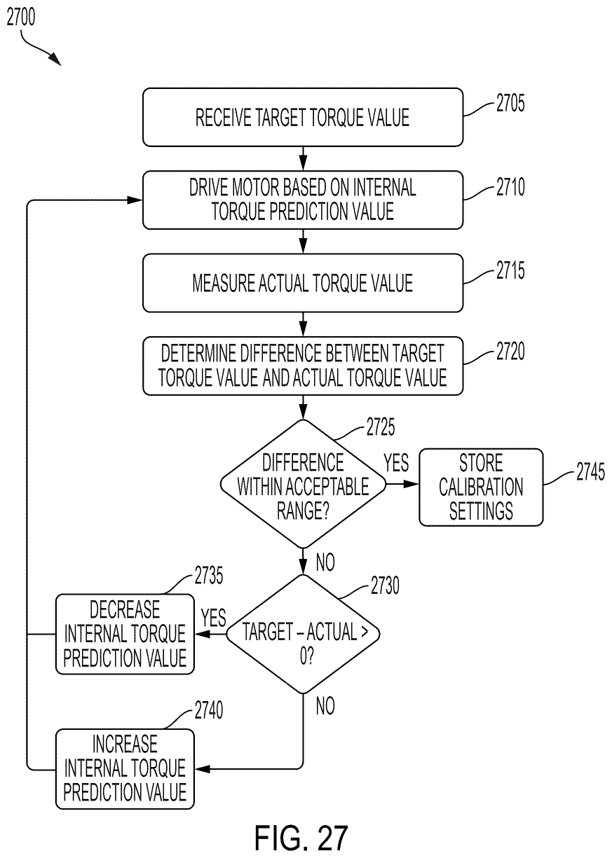

FIG. 27 provides a method 2700 performed by the controller 226 for calibrating the internal torque prediction value for the impact tool 104 for a particular application. At block 2705, the controller 226 receives a target torque value (e.g., a real-world target torque value). The target torque value may be provided for example, via the external device 108, via a user interface of the impact tool 104, or the like. At block 2710, the controller 226 drives the motor 214 based on the internal torque prediction value. In some embodiments, the internal torque prediction value is preset to an arbitrary number (e.g., to 30, 40, 50, 60, and the like) prior to calibration. At block 2715, the controller 226 measures or receives the actual torque value applied to a fastener. For example, a torque wrench is used to measure the actual torque value and the actual torque value is provided to the controller 226. In some implementations, a user provides the actual torque value (as measured by the torque wrench) to the controller 226 via the user interface of the impact tool 104, via the external device 108, or the like.

At block 2720, the controller 226 determines a difference between the target torque value and the actual torque value. For example, the controller 226 subtracts the actual torque value from the target torque value. At block 2725, the controller 226 determines whether the difference between the target torque value and the actual torque value is within an acceptable range. When the difference is not within an acceptable range (“NO” at block 2725), the controller 226 proceeds to block 2730.

At block 2730, the controller 226 determines whether the difference between the target torque value and the actual torque value (or, specifically, the actual torque value subtracted from the target torque value) is greater than zero. When the difference between the target torque value and the actual torque value is greater than zero (“YES” at block 2730), the controller 226 proceeds to block 2735 and decreases the internal torque prediction value. When the difference between the target torque value and the actual torque value (or, specifically, the actual torque value subtracted from the target torque value) is less than zero (“NO” at block 2730), the controller 226 proceeds to block 2740 and increases the internal torque prediction value. After increasing or decreasing the internal torque prediction value, the controller 226 returns to block 2710.

When the difference is within an acceptable range (“YES” at block 2725), the controller 226 proceeds to block 2745. At block 2745, the controller 226 stores the calibration settings in the memory 232. For example, the controller 226 stores the value for the internal torque prediction value that corresponds to the target torque value in the memory 232.

Thus, embodiments described herein provide, among other things, techniques for determining output torque of an impact driver using machine learning algorithms. Various features and advantages are set forth in the following claims.

What is claimed is:

1. A power tool comprising:
a motor;
an output drive device;
an anvil coupled to the output drive device;
a hammer connected to the motor and configured to engage the anvil when driven by the motor; and
a controller including an electronic processor and a memory, the controller configured to:
receive a target torque value,
drive the motor based on an internal torque prediction value,
determine a difference between the target torque value and an actual torque value provided by the motor,
determine whether the difference between the target torque value and the actual torque value is within an acceptable range, and
store, in response to the difference between the target torque value and the actual torque value being within the acceptable range, the internal torque prediction value in the memory, wherein the internal torque prediction value is associated with the target torque value in the memory.

2. The power tool of claim 1, further comprising:
a user interface, and wherein the controller is configured to:
receive the target torque value via the user interface.

3. The power tool of claim 2, wherein the controller is further configured to:
receive, via the user interface, the actual torque value provided by the motor.

4. The power tool of claim 1, wherein the controller is configured to:
determine, in response to the difference between the target torque value and the actual torque value not being within the acceptable range, whether the difference between the target torque value and the actual torque value is greater than zero;
decrease, in response to the difference between the target torque value and the actual torque value being greater than zero, the internal torque prediction value, and
drive the motor based on the decreased internal torque prediction value.

5. The power tool of claim 1, wherein the controller is configured to:
determine, in response to the difference between the target torque value and the actual torque value not being within the acceptable range, whether the difference between the target torque value and the actual torque value is greater than zero;
increase, in response to the difference between the target torque value and the actual torque value being less than zero, the internal torque prediction value, and
drive the motor based on the increased internal torque prediction value.

6. The power tool of claim 1, wherein the controller is further configured to:
repeatedly drive the motor based on the internal torque prediction value; and
determine the difference between the target torque value and the actual torque value for a predetermined number of impact operations.

7. The power tool of claim 6, wherein the controller is further configured to:
modify the internal torque prediction value after each impact operation until the difference between the target torque value and the actual torque value is within the acceptable range.

8. A method for calibrating an impact driver, the impact driver including a motor, an output drive device, an anvil coupled to the output drive device, and a hammer connected to the motor and configured to engage the anvil when driven by the motor, the method comprising:
receiving a target torque value;
driving the motor based on an internal torque prediction value;
determining a difference between the target torque value and an actual torque value provided by the motor,
determining whether the difference between the target torque value and the actual torque value is within an acceptable range, and
storing, in response to the difference between the target torque value and the actual torque value being within the acceptable range, the internal torque prediction value in a memory, wherein the internal torque prediction value is associated with the target torque value in the memory.

9. The method of claim 8, wherein receiving the target torque value includes receiving, via a user interface, the target torque value.

10. The method of claim 9, further comprising:
receiving, via the user interface, the actual torque value provided by the motor.

11. The method of claim 8, further comprising:
determining, in response to the difference between the target torque value and the actual torque value not being within the acceptable range, whether the difference between the target torque value and the actual torque value is greater than zero;
decreasing, in response to the difference between the target torque value and the actual torque value being greater than zero, the internal torque prediction value; and
driving the motor based on the decreased internal torque prediction value.

12. The method of claim 8, further comprising:
determining, in response to the difference between the target torque value and the actual torque value not being within the acceptable range, whether the difference between the target torque value and the actual torque value is greater than zero;
increasing, in response to the difference between the target torque value and the actual torque value being less than zero, the internal torque prediction value; and
driving the motor based on the increased internal torque prediction value.

13. The method of claim 8, further comprising:
repeatedly performing the steps of driving the motor based on the internal torque prediction value and determining the difference between the target torque value and the actual torque value for a predetermined number of impact operations.

14. The method of claim 13, further comprising:
modifying the internal torque prediction value after each impact operation until the difference between the target torque value and the actual torque value is within the acceptable range.

15. A power tool comprising:
a motor;
an output drive device;
an anvil coupled to the output drive device;
a hammer connected to the motor and configured to engage the anvil when driven by the motor;
a hammer translation sensor configured to generate a hammer translation signal indicative of a position of the hammer;
an anvil rotation sensor configured to generate an anvil rotation signal indicative of a position of the anvil; and
a controller including an electronic processor and a memory, the memory storing a machine learning model and a physics model, the controller configured to:
receive the hammer translation signal,
receive the anvil rotation signal,
provide the hammer translation signal and the anvil rotation signal to a signal processing model, the signal processing model including the physics model and the machine learning model, and
determine, based on an output from the signal processing model, an estimated output torque of the power tool.

16. The power tool of claim 15, further comprising:
a battery pack; and
a voltage sensor configured to generate a voltage signal indicative of a voltage of the battery pack,
wherein the controller is further configured to:
receive the voltage signal, and
provide the voltage signal to the signal processing model, wherein the signal processing model includes a battery compensation model.

17. The power tool of claim 15, wherein the controller is further configured to:
determine, based on the estimated output torque of the power tool, a characteristic of a fastener driven by the output drive device.

18. The power tool of claim 17, wherein, to determine the characteristic of the fastener, the controller is configured to compare the output of the signal processing model to stored fastener characteristic graphs.

19. The power tool of claim 15, wherein the anvil rotation sensor includes:
an inductive sensor configured to inject a current into a transmitting circuit trace to generate a magnetic field; and
an anvil lug configured to pass through the magnetic field generated by the transmitting circuit trace in response to rotation of the anvil.

20. The power tool of claim 15, wherein the hammer translation sensor includes:
an inductive sensor configured to inject a current into a transmitting circuit trace to generate a magnetic field; and
a hammer lug configured to pass through the magnetic field generated by the transmitting circuit trace in response to translation of the hammer.
